(19) United States
(12) Patent Application Publication
(10) Pub. No.: US 2003/0182379 A1
(43) Pub. Date: Sep. 25, 2003

(54) Maintaining digital transmitter distribution lists

(76) Inventor: Steven G. Henry, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/106,946

(22) Filed: Mar. 25, 2002

(51) Int. Cl. G06F 15/16

(52) U.S. Cl. 709/206

(57) ABSTRACT

Digital transmitter distribution list maintenance allows discovery of invalid email addresses prior to their actual use in the distribution of digital files, and aids in the replacement of invalid addresses with valid addresses. In one implementation, a CPU resource evaluator module determines that the available CPU resources of the digital transmitter exceed a threshold value, typically indicating that the digital transmitter is substantially idle. An email query module queries email servers to determine if email addresses on a distribution list are valid. Where an address is invalid, an administrator messaging module sends an automated email to the administrator of the email server asking for an updated email address. Where an updated address is available, an address update module replaces the invalid email address with the updated email address.

### TECHNICAL FIELD

This disclosure relates to a system and method to maintain digital transmitter lists, and in particular, to efficiently use the idle time of a digital transmitter to perform this task.

### BACKGROUND

Digital transmitters such as multifunction peripherals (MFPs) and digital network copiers frequently include extensive distribution lists to aid in the automated sending of one document to a number of locations. Distribution lists might include the recipient's name, and would include the recipient's email address, fax number or other digital destination.

In an exemplary digital sending operation, a hardcopy of a document can be presented to the scanner portion of a digital transmitter. The digital representation of the document is then saved in a format, such as PDF. The PDF document is then attached to an email document which is sent to every member of a distribution list. In this manner, an administrator may communicate with a number of team members or a sales manager may communicate with a number of sales associates.

Unfortunately, as the email addresses of the recipients change over time, such distribution lists become outdated. Accordingly, there is a need to update such list periodically. Unfortunately updating such address lists has previously been a very time consuming process, wherein considerable manual effort was required. Moreover, the updating process has typically been undertaken only after failure to properly maintain the distribution list has resulted in one or more addresses failing to successfully communicate.

Present systems and methods fail to provide automation, and therefore result in poor performance and excessive costs. Additionally, present systems and methods fail to provide warning to the administrator of an invalid address prior the failure of a digital sending operation. Accordingly, an improved system and method to maintain digital transmitter distribution lists would be beneficial.

### SUMMARY

A system and method to maintain distribution lists contained within a digital transmitter allows discovery of invalid email addresses prior to their actual use in the distribution of digital files, and aids in the replacement of invalid addresses with valid addresses. In one implementation, a CPU resource evaluator module determines that the available CPU resources of the digital transmitter exceed a threshold value, typically indicating that the digital transmitter is substantially idle. An email server query module queries email servers to determine if email addresses on a distribution list are valid. Where an address is invalid, an administrator messaging module sends an automated email to the administrator of the email server asking for an updated email address. Where an updated address is available, an address update module replaces the invalid email address with the updated email address.

### BRIEF DESCRIPTION OF THE DRAWINGS

The same numbers are used throughout the drawings to reference like features and components.

FIG. 1 is block diagram illustrating a digital transmitter exemplified by a multifunctional peripheral device in a network environment.

FIG. 2 is block diagram illustrating a detailed view of portions of the multifunction peripheral device of FIG. 1.

FIG. 3 is a block diagram that illustrates a detailed view of the distribution lists of FIG. 1.

FIG. 4 is a flow diagram that describes a method to maintain an email distribution list.

FIG. 5 is a flow diagram that describes an extension of the method of FIG. 4, describing the efficient management of multiple email distribution lists contained on one multifunctional device.

FIG. 6 is a flow diagram that describes an extension of the method of FIG. 4, describing the testing an email address thought to be invalid.

FIG. 7 is a flow diagram that describes an extension to the method of FIG. 4, describing a method for determining the order by which email servers are queried to determine email address validity.

### DETAILED DESCRIPTION

Introduction

A system and method to maintain distribution lists contained within a digital transmitter allows discovery of invalid email addresses prior to their actual use in the distribution of digital files, and aids in the replacement of invalid addresses with valid addresses. A CPU resource evaluator module determines that the available CPU resources of the digital transmitter exceed a threshold value, typically indicating that the digital transmitter is substantially idle. An email query module queries email servers to determine if email addresses on a distribution list are valid. Where an address is invalid, an administrator messaging module sends an automated email to the administrator of the email server asking for an updated email address. Where an updated address is available, an address update module replaces the invalid email address with the updated email address. The owner of the distribution list may also be notified of the invalid address, and asked for an updated address. Additionally, an email message in HTML format may be sent to the invalid email address in hopes that the address has been reactivated. When opened, such an email message automatically generates a response, possibly routed through a third party, which is then received by the digital transmitter, confirming reactivation of the email address.

Exemplary Multifunctional Peripheral Device Architecture

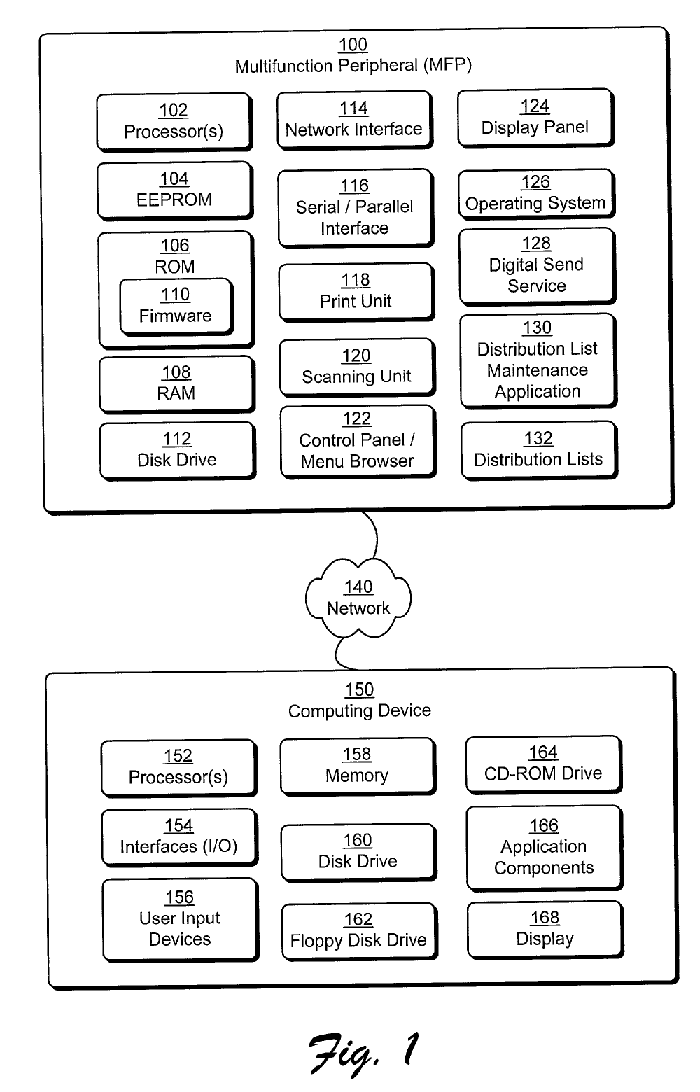

FIG. 1 illustrates a computing device 150 and a digital transmitter, illustrated for purposes of example by a multifunction peripheral (MFP) 100, attached to a network 140. Examples of digital transmitters include HewlettPackard's Digital Senders, MFPs, scanners, network copiers and other devices that are capable of transmitting information on a network. A multifunction peripheral device is a device capable of multiple functions which are related, but not limited to, printing, copying, scanning, text recognition, sending and receiving faxes, print media handling, and/or data communication, either by print media or e-media, such as via email or electronic fax.

Multifunction peripheral device 100 includes one or more processors 102, an electrically erasable programmable read-only memory (EEPROM) 104, ROM 106 (non-erasable), and a random access memory (RAM) 108. Although multifunction peripheral device 100 is illustrated having an EEPROM 104 and ROM 106, a particular device may only include one of the memory components. Additionally, although not shown, a system bus typically connects the various components within multifunction peripheral device.

Multifunction peripheral device 100 also includes a software or firmware component 110 that can be implemented as a memory module stored on ROM 106 or as code loaded into memory from storage, such as disk drive 112. Firmware 110 is programmed and tested like software, and is distributed with the multifunction peripheral device 100. Firmware 110 can be implemented to coordinate operations of the hardware within multifunction peripheral device 100 and typically contains low-level programming constructs used to perform such operations.

Processor(s) 102 process various instructions to control the operation of multifunction peripheral device 100 and to communicate with other electronic and computing devices. The memory components, EEPROM 104, ROM 106, and RAM 108, store various information and/or data such as configuration information, fonts, templates, print data, scanned image data, and menu structure information. Although not shown, a particular multifunction peripheral device can also include a flash memory device in place of or in addition to EEPROM 104 and ROM 106.

Multifunction peripheral device 100 also includes a disk drive 112, a network interface 114, and a serial and/or parallel interface 116. Disk drive 112 provides additional storage for program code, data being printed, copied, scanned, and/or faxed, or other information maintained by multifunction peripheral device 100. Disk drive 112 may also include storage for executable program code, such as the operating system 126 and applications running on the digital send service 128 or distribution list manager 130. Although multifunction peripheral device 100 is illustrated having both RAM 108 and a disk drive 112, a particular multifunction peripheral device may include either RAM 108 or disk drive 112, depending on the storage needs of the multifunction peripheral device.

Network interface 114 provides a connection between multifunction peripheral device 100 and a data communication network. Network interface 114 allows devices coupled to a common data communication network to send print jobs, faxes, menu data, and other information to multifunction peripheral device 100 via the network. Similarly, the serial and/or parallel interface 116 provides a data communication path directly between multifunction peripheral device 100 and another electronic or computing device. Although multifunction peripheral device 100 is illustrated having a network interface 114 and serial and/or parallel interface 116, a particular multifunction peripheral device may only include one such interface component.

Multifunction peripheral device 100 also has a print unit 118 that includes mechanisms arranged to selectively apply ink (e.g., liquid ink, toner, thermal paper, etc.) to a print media such as paper, plastic, fabric, and the like in accordance with print data corresponding to a print job. For example, print unit 118 can include a conventional laser printing mechanism that selectively causes toner to be applied to an intermediate surface of a drum or belt. The intermediate surface can then be brought within close proximity of a print media in a manner that causes the toner to be transferred to the print media in a controlled fashion. The toner on the print media can then be more permanently fixed to the print media, for example, by selectively applying thermal energy to the toner.

Print unit 118 can also be configured to support duplex printing, for example, by selectively flipping or turning the print media as required to print on both sides. Those skilled in the art will recognize that there are many different types of print units available, and that for the purposes of the present invention, print unit 118 can include any of these different types.

Multifunction peripheral device 100 also has a scanning unit 120 that can be implemented as an optical scanner to produce machine-readable image data signals that are representative of a scanned image, such as a photograph or a page of printed text. The image data signals produced by scanning unit 120 can be used to reproduce the scanned image on a display device, such as a computer display or a printer.

Multifunction peripheral device 100 also includes a control panel and menu browser 122, and a display panel 124. The control panel and menu browser 122 allows a user of the multifunction peripheral device 100 to navigate the device's menu structure. Control panel 122 can be indicators or a series of buttons, switches, or other selectable controls that are manipulated by a user of the multifunction peripheral device. Display panel 124 is a graphical display that provides information regarding the status of the multifunction peripheral device 100 and the current options available to a user through the menu structure.

Multifunction peripheral device 100 typically provides an operating system 126 that provides a runtime environment within which software applications, data structures or components can exist and operate. Those skilled in the art will recognize that there are many different types of available runtime environments. A runtime environment facilitates the extensibility of the multifunction peripheral device 100 by supporting the operation of various interfaces, data structures and applications that provide enhanced functionality.

General reference is made herein to multifunction and/or data and media reproduction devices, such as the multifunction peripheral device 100. Although specific examples may refer to one or more multifunction peripheral devices having particular functionalities, such examples are not meant to limit the scope of the claims or the description, but are meant to provide a specific understanding of the described implementations. Furthermore, it is to be appreciated that the described components are exemplary, and are not intended to limit application of the claimed subject matter to multifunction and reproduction devices that include only these components. Accordingly, other devices having components different from and/or in addition to those described herein can be used in implementing the described techniques and systems.

FIG. 1 additionally illustrates a digital send service 128, a distribution list maintenance application 130, and a plurality of distribution lists 132. The digital send service is an application that coordinates the network interface 114, the scanning unit 120 and other devices to control the functionality of the multifunctional peripheral 100. The distribution list maintenance application efficiently manages the distribution lists, as will be seen in greater detail, below. As a practical matter, the digital send service, the distribution list maintenance application, and the plurality of distribution lists may be located on a digital transmitter, such as an MFP or a Hewlett-Packard Company's Digital Sender, or alternatively, may be located on the server 150 or other computing device in communication with the digital transmitter.

FIG. 1 additionally illustrates various components of an exemplary computing device 150 that can be utilized in conjunction with the MFP 100. The computing device and MFP are typically connected by a network 140, which may be a LAN, the Internet, a simple cable or other connective device. The computer 150 includes one or more processors 152, interfaces 154 for inputting and outputting data, and user input devices 156. Processor(s) 152 process various instructions to control the operation of computer 150, while interfaces 154 provide a mechanism for computer 150 to communicate with other electronic and computing devices, such as multifunction peripheral device 100 (FIG. 1). User input devices 156 include a keyboard, mouse, pointing device, and/or other mechanisms for interacting with, and inputting information to computer 150.

Computer 150 also includes a memory 158 (such as ROM and/or RAM), a disk drive 160, a floppy disk drive 162, and a CD-ROM drive 164. Memory 158, disk drive 160, floppy disk drive 162, and CD-ROM drive 164 provide data storage mechanisms for computer 150. Although not shown, a system bus typically connects the various components within the computing device 150.

Computer 150 also includes application components 166 and can include an integrated display device 168, such as for a portable laptop computer, personal digital assistant (PDA), and similar computing devices. Application components 166 provide a runtime environment in which software applications or components can run or execute on processor(s) 152.

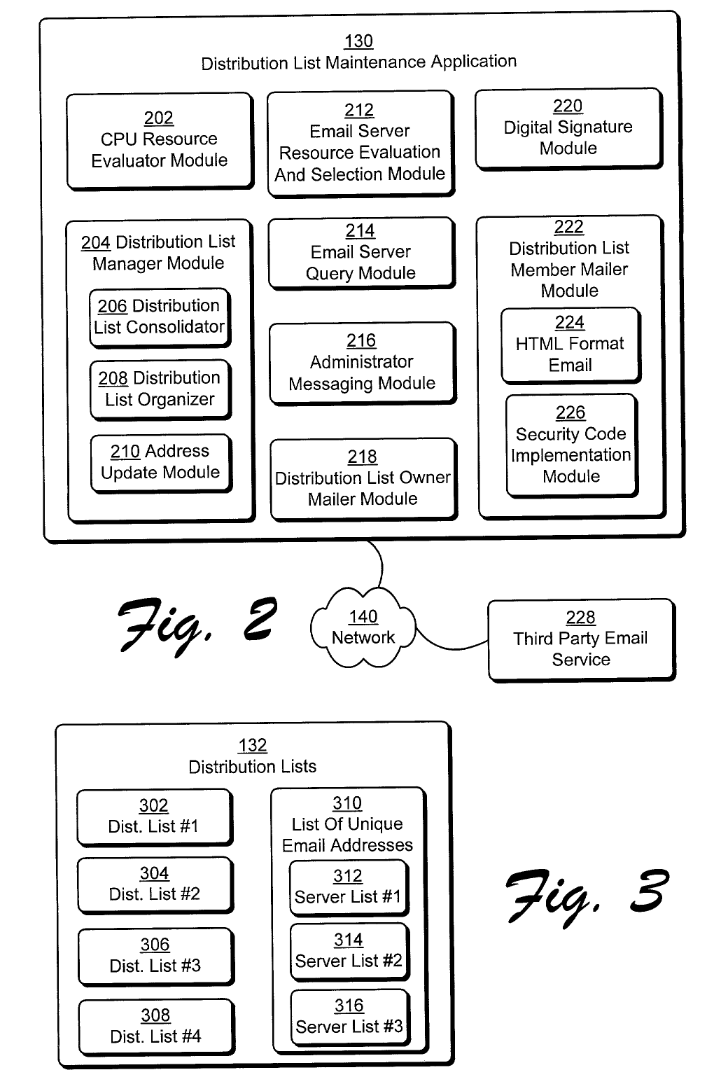

FIG. 2 shows a detailed view of the distribution list maintenance application 130, which may be located in a digital transmitter, such as the multifunction peripheral 100, or within the server 150. The distribution list maintenance application constitutes a system, which may include computer executable instructions. The instructions may be grouped in modules, and implemented in software, software media, firmware, or in hardware, such as in an application specific integrated circuit. The distribution maintenance application determines the validity of email addresses contained within the distribution lists. Where an email address is found to be invalid, the distribution list maintenance application attempts to replace the invalid address with a valid address prior to its use.

An exemplary CPU resource evaluator module 202 is implemented in software or firmware, and is configured to provide means for determining that the available CPU resources of a digital transmitter exceed a threshold value. Determining that the available CPU resources exceed the threshold value confirms that the digital transmitter is in a position to perform distribution list maintenance without adversely affecting other functionality. Since many digital transmitters spend a substantial amount of time in a standby or idle mode, the available CPU resources will exceed a threshold value during these times.

An exemplary distribution list manager module 204 is implemented in software or firmware, and is configured to provide means for managing the distribution lists 132. In particular, the distribution list manager is configured to prevent the email server query module 214 from repeatedly querying an email server about the validity of a single email address, based on the presence of that email address in more than one distribution list. The distribution list manager module, in one implementation: consolidates, for purposes of distribution list management only, a number of distribution lists into a list of unique email addresses wherein duplicate email addresses are removed; organizes the unique list of email addresses according to the email server associated with different email addresses contained within the list; and replaces invalid email addresses, contained within a distribution list, with an updated email addresses.

An exemplary distribution list consolidator module 206 is implemented in software or firmware, and is configured to provide means for consolidating the various distribution lists into a single list of unique email addresses. Accordingly, copies of email addresses which are found in more than one distribution list are removed, resulting in a list containing one copy of each email address contained any of the distribution lists. Such a list facilitates validation of each email address without duplication of effort, e.g. validating a single email address twice. Alternative means to perform checks to prevent repetition of email address validity checks, such as a searching process, could be substituted to prevent such duplication. Therefore, the consolidator module is only representative of strategies that prevent the repeated validation of any given email address.

An exemplary distribution list organizer 208 is implemented in software or firmware, and is configured to provide means for organizing the list of unique email addresses according to the email server with which each address is associated. Thus, email addresses associated with each given email server may be grouped, thereby facilitating the validation of a group of email addresses after opening a connection with the given email server. Alternative means, such as a searching process, could be substituted to find each email address associated with the given server, as needed.

An exemplary address update module 210 is implemented in software or firmware, and is configured to provide means for receiving an updated email address, and for replacing an invalid email address with the updated email address. Such updated email addresses are usually supplied by the administrator of the email server associated with the either of the email addresses, the owner of the distribution list with which either of the email addresses is associated, or the person or organization with which either of the email addresses is associated.

An exemplary email server resource evaluation and selection module 212 is implemented in software or firmware. The module is configured to provide means for confirming that a given email server has the resources to devote to distribution list maintenance without unduly slowing its other functions. The module is also configured to rank the email servers associated with email addresses in the distribution list(s) according to unused CPU resources. Using the ranking of the email servers, the email server query module 214 can efficiently query email servers in a logical order, based on one or more criteria. The criteria could include the amount of CPU resources that each email server has to devote to distribution list maintenance. Additional criteria could include the number of email addresses which are associated with a given email server.

An exemplary email server query module 214 is implemented in software or firmware, and is configured to provide means for querying an email server to determine if an email address is still valid. This query can be performed in a well-known manner, such as that implemented at http://network-tool.com. For example, the email server smtp.example.com (or similar email server) is queried about the validity of an email address, such as Chris@example.com.

An exemplary administrator messaging module 216 is implemented in software or firmware, and is configured to provide means for sending an automated email message to an administrator of the email server associated with an invalid email address. The message may ask the administrator to forward an updated email address to replace the invalid email address. In many organizations, email addresses may be based in part upon the names of corporate subsidiaries, which may change frequently. As a result, email addresses may also change frequently. To increase the likelihood of the administrator responding, the request may include a digital signature, which may be obtained from the digital signature module 220.

An exemplary distribution list owner mailer module 218 can be implemented in software or firmware. It is configured to provide means for sending, if the administrator does not send a reply to the message sent by the exemplary administrator messaging module 216, a second automated email message to an owner of the distribution list within which the invalid email address is contained. The second automated email message reports that the invalid email address has been found to be invalid, after an enquiry made to the email server associated with the address. To increase the likelihood of the distribution list owner responding, the request may include a digital signature.

An exemplary digital signature module 220 is implemented in software or firmware, and is configured to provide means for supplying and attaching a digital signature to email messages to the administrator of the email server and to the owner of the distribution list, both associated with the invalid email address. Particularly where the email server administrator, the distribution list owner and the digital transmitter are not within the same organization, the digital signature should reassure the recipient that the automated email message is from a trusted source.

A distribution list member mailer module 222 is implemented in software or firmware, and is configured to provide means for sending, after a delay, an html format email 224 from the digital transmitter to the invalid email address. The delay will allow the invalidity of the email address to correct itself, and may be of almost any desired duration, such as several hours. Where a software problem was present on the email server, the delay may allow this problem to be corrected. The email may contain a security code from the security code implementation module 226.

The HTML format email message 224 is configured to provide means for automatically replying to the digital transmitter, including a copy of the code, upon opening by an owner of the invalid email address. Should the automatic reply be received, it would indicate that the invalid email address is actually valid. The distribution list member mailer module 222 is therefore configured to compare the security code to the copy of the security code, and to determine if invalid email address is actually valid.

In one implementation, the email message 224 contains the URL (uniform resource locator) of a third party email service 228. An example of such a third party email server is seen at http://www.itraceyou.com. The email message is adapted so that, upon opening, the third party email service is contacted. A CGI (computer gateway interface) script or similar software running on the third party email service causes the generation of an email message that is sent to the distribution list maintenance application, thereby confirming that the HTML format email message was received, thereby confirming the authenticity of the associated address. In another implementation, the technology supporting the functionality of the third party email message service is contained within the digital transmitter 140 or server 150.

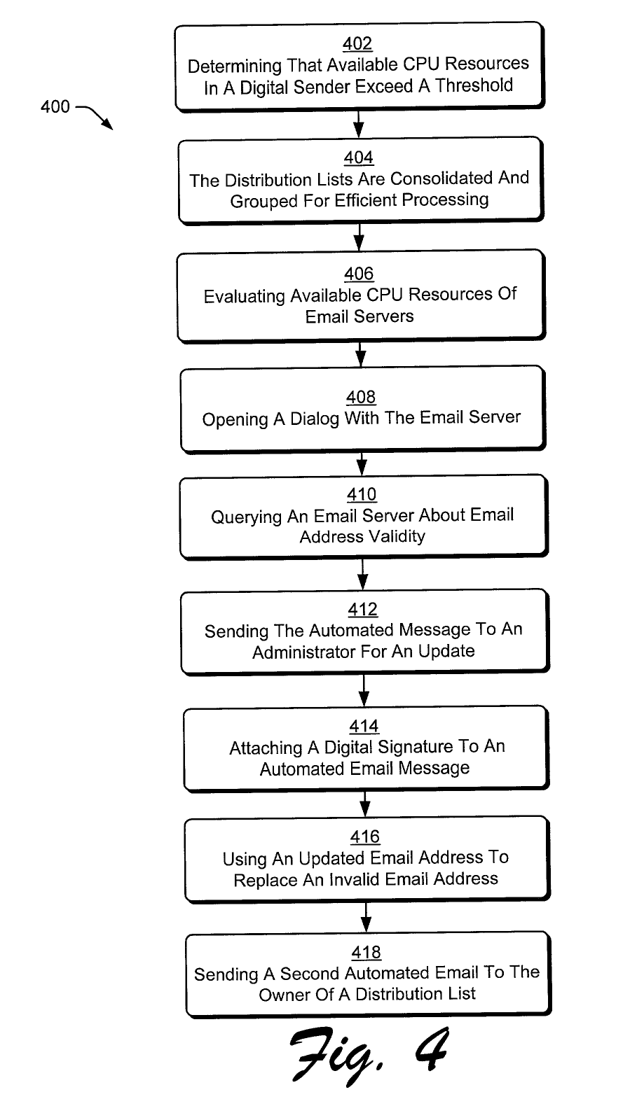

FIG. 3 shows a detailed view of the distribution lists 132 introduced in FIG. 1. Four exemplary distribution lists 302, 304, 306 and 308 could be associated with four groups of people, such as corporate departments, to whom digital information will be sent. A list of unique email addresses 310 is produced by the distribution list consolidator 206 (seen in FIG. 2). The list of unique email addresses is segmented by the distribution list organizer 208 (also seen in FIG. 2) into a number of lists 312, 314, 316, wherein the email addresses in each list are associated with a particular email server.

FIG. 4 shows an exemplary implementation of a method 400 to maintain distribution lists on a digital transmitter, such as a multifunctional peripheral. In one implementation, the distribution list maintenance application 130 of FIGS. 1 and 2 is configured to perform the method 400.

At block 402, it is determined that the available CPU resources of a digital transmitter exceed a threshold level. Typically, this means that the digital transmitter is substantially idle, but could simply indicate that the available CPU resources are sufficient, despite activity, to warrant further activity. In the implementation of FIG. 2, this functionality is performed by the CPU resource evaluator module 202.

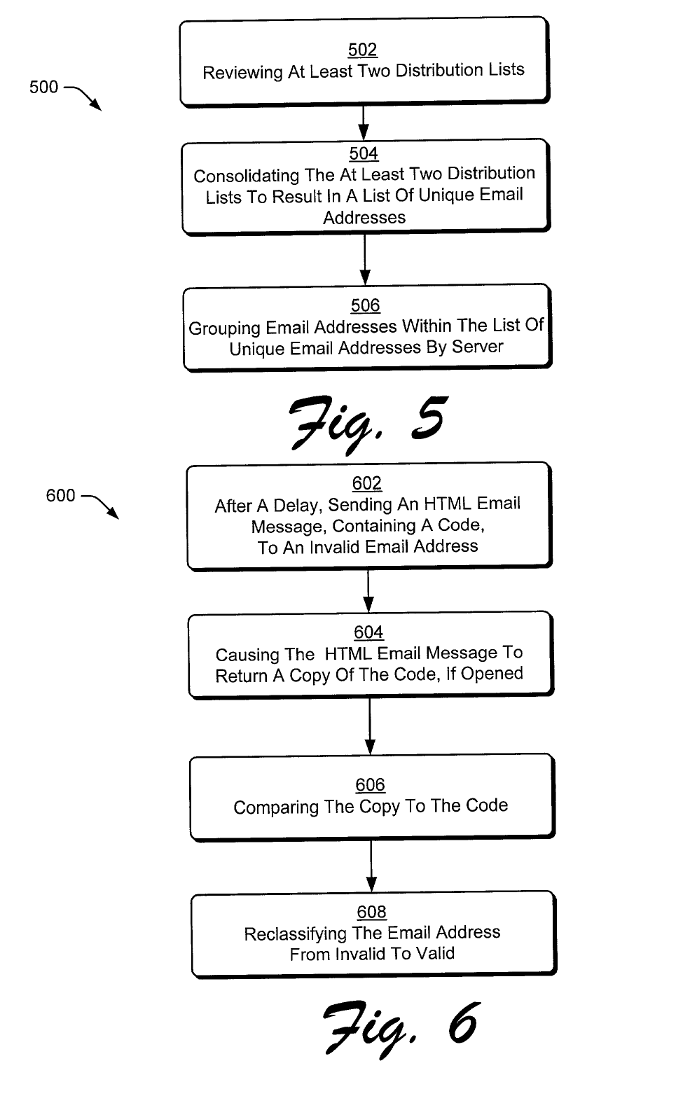

At block 404, where there is more than one distribution list on the digital transmitter, the distribution list manager (seen as 204 in FIG. 2) is optionally invoked. The distribution list manager enhances efficiency by discovering duplicate email addresses within the distribution lists, and by associating groups of email addresses with their respective email servers. A discussion of the implementation and operation of the distribution list manager is seen in FIG. 5.

At block 406, it is optionally determined that the available CPU resources of an email server exceed a threshold value. In one implementation, the resources of the email server can be measured by sending an SMTP command or request and measuring the elapsed time until an SMTP response is received. Where the digital transmitter and the email server on located on the same intranet, the elapsed time can be normalized to account for delays caused by network traffic. In addition, for all email servers, refusal to accept a connection indicates that the server is too busy. Accordingly, it may be determined if the resources of an email server are sufficient to perform additional functionality without undue burden. In the implementation of FIG. 2, this functionality is performed by email server resource evaluation module 212. As will be seen in greater detail below, FIG. 7 illustrates a method by which email servers may be ranked. Such ranking of the email servers coordinates the order by which email addresses may be verified.

At block 408, a connection is opened with an email server which is associated with one or more email addresses on a distribution list. For example, where one or more email addresses on the distribution list are associated with the domain example.com, a connection is opened with an email server having the address smtp.example.com.

At block 410, the email server smtp.example.com (or similar email server) is queried about the validity of an email address, such as Chris@example.com. This query can follow a well-known format, such as that implemented at http://network-tool.com. The query provides information on the validity of the email address. The query process is repeated for all email addresses associated with an email server. Additional email servers are queried in a similar manner, with respect to email addresses within their domains.

At block 412, where an email address has been found to be invalid, an automated email message is sent to the administrator of the associated email server. Such a message may be sent by the administrator messaging module 216 of FIG. 2.

At block 414, a digital signature generated by the digital signature module 220 of FIG. 2 may be attached to the automated email address generated at block 412. The digital signature provides assurance to the administrator who is the recipient of the email generated at block 412 that the automated email is from a trusted source.

At block 416, where a reply containing an updated email address is received from the administrator of the email server by the digital transmitter (in response to the automated email request of block 412), the updated email address is used to replace the invalid email address. This management process may be handled by the address update module 210 of FIG. 2.

At block 418, a second automated email may be sent, this time to the owner of the distribution list, informing the distribution list owner that the email address has been found to be invalid, and asking for an updated email address to use as a replacement. The second automated email may include a form that organizes the reply of the distribution list owner so that the updated email address may be substituted in an automated fashion. The functionality may be performed by the distribution list owner mailer module 218 of FIG. 2.

FIG. 5 shows an exemplary implementation of a method 500 to maintain distribution lists. In one implementation, the distribution list maintenance application 204 of FIG. 2 is configured to perform the method 500, which is an enhancement of block 404 of method 400, seen in FIG. 4.

At block 502, at least two distribution lists may be reviewed. The reviewing process can include a determination of the existence of email address that are in two or more distribution lists, or a determination of the existence of more than one email server associated with the email addresses.

At block 504, the at least two distribution lists are consolidated to into a single list, wherein duplicate email addresses are discarded. The consolidation process may be performed by the distribution list consolidator 206, seen in FIG. 2. Thus, a group of distribution lists, such as lists 302, 304, 306, 308 of FIG. 3, can be consolidated into a single list of unique email addresses 310, also seen in FIG. 3. In an alternative to consolidation, a searching procedure can be used to determine if an email address to be tested for validity has previously been tested.

At block 506, the email addresses within the unique list of email addresses are grouped according to the email server associated with each address. For example, the distribution list organizer 208 of FIG. 2 can be used to sort a list of unique email addresses 310, thereby producing a plurality of groups 312, 314, 316, as seen in FIG. 3.

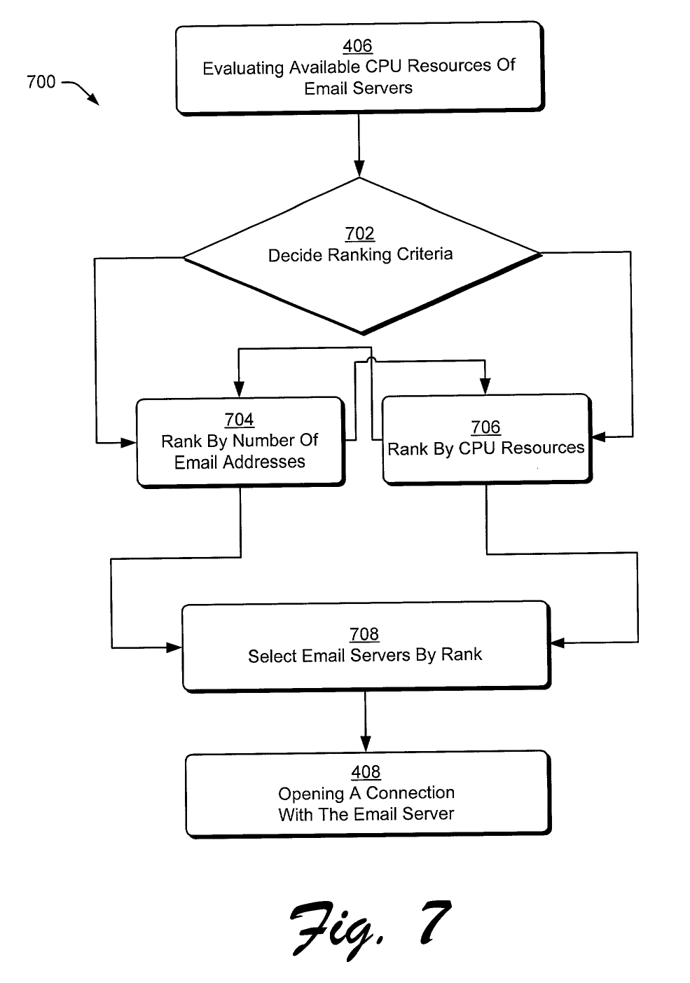

FIG. 6 shows an exemplary implementation of a method 600 to validate an email addresses thought to be invalid. In one implementation, the distribution list member mailer module 222 of FIG. 2 is configured to perform the method 600, which is an extension of method 400, and may be performed following block 418 of FIG. 4.

At block 602, a delay following the query at block 410 of FIG. 4 provides time for a technical difficulty with an email server to be resolved. Resolution of the technical difficulty may allow an invalid email address to regain its validity. Following the delay, an HTML (hyper text mark-up language) based email message is sent to the email address thought to be invalid. A unique code is included within the email address, and a record of the code and email address is recorded.

At block 604, where the invalid email address was only temporarily invalid, the email message is actually opened by the owner of the email address, who is on one or more of the distribution lists. HTML code within the email address causes it to communicate with the third party email service. In response, the third party email service sends an email to the distribution list member mailer module. Included within the email message is a copy of the code that was included in the HTML email message. Alternatively, the functionality of the third party email service is incorporated into the distribution list maintenance application, and located on either the multifunction peripheral or the server.

At block 606, the copy of the code received from the HTML email message is compared to the code sent. Where the code is the same, it is assumed that the email address is functional, and should be reclassified as valid.

At block 608, the email address is entered into appropriate databases as a valid address, typically by the address update module 210 of the distribution list manager 204 of FIG. 2.

FIG. 7 shows an exemplary implementation of a method 700 of ordering the email servers to efficiently validate the email addresses associated with the servers. In one implementation, the distribution list member mailer module 212 of FIG. 2 is configured to perform the method 700. The method 700 is an enhancement to method 400, and is inserted between blocks 406 and 408.

At block 702, the ranking criteria are decided. The criteria used to prioritize email servers may include: the number of email addresses, contained within the distribution lists or a list of unique email addresses, associated with each server; the level of available CPU resources associated with each email server; the level of network activity associated with the network with which each server is most active; or other criteria.

At block 704, where the number of email addresses associated with each email server is to be used to rank email servers, the number of email addresses associated with each server is calculated. Thus, the email server associated with the most email addresses contained within the distribution lists is ranked first, and other email servers are ranked in a similar manner.

At block 706, where the level of available CPU resources associated with each email server is to be used to rank email servers, the email server with the greatest CPU resources to be used to validate email addresses is ranked first, while email servers with less CPU resources ranked lower.

Note that block 704 can follow block 706, block 706 can follow block 704, or block 704 and block 706 can be performed as alternatives. Where both blocks are performed, available CPU resources and the number of email addresses associated with the mail servers are both taken into account in the ranking process. In one implementation, where email servers available CPU resources exceed a threshold, they are ranked according to the number of email addresses associated with each server.

At block 708, email servers are selected by rank. After selection, the email addresses associated with each email server are validated. After the email addresses associated with one email server are validated, a further email server is selected and the process is repeated until all email addresses in the distribution lists are found to be valid or invalid.

Conclusion

Accordingly, a system and method of maintaining distribution lists contained within a digital transmitter allows discovery of invalid email addresses prior to their actual use in the distribution of digital files, and aids in the replacement of invalid addresses with valid addresses. A CPU resource evaluator module determines that the available CPU resources of the digital transmitter exceed a threshold value, typically indicating that the digital transmitter is substantially idle. An email query module queries email servers to determine if email addresses on a distribution list are valid. Where an address is invalid, an administrator messaging module sends an automated email to the administrator of the email server asking for an updated email address. Where an updated address is available, an address update module replaces the invalid email address with the updated email address.

Although the disclosure has been described in language specific to structural features and/or methodological steps, it is to be understood that the appended claims are not limited to the specific features or steps described. Rather, the specific features and steps are exemplary forms of implementing this disclosure. For example, while the distribution list manager has been disclosed to produce a list of unique email addresses, and to further group the unique email addresses according to their email server, other searching, sorting and data manipulation techniques could be used to prevent repeatedly attempting to verify email addresses on more than one distribution list. Additionally, while one or more methods have been disclosed by means of flow charts and text associated with the blocks, it is to be understood that the blocks do not necessarily have to be performed in the order in which they were presented, and that an alternative order may result in similar advantages.

1. A method to maintain distribution lists, comprising:
determining that available CPU resources of a digital transmitter exceed a threshold value;
querying an email server to determine if an email address contained within a distribution list on the digital transmitter is still valid;
where the email address is an invalid email address, sending an automated email message asking for an updated email address; and
if a reply is sent, receiving the reply containing the updated email address and replacing the invalid email address with the updated email address.

2. The method of claim 1, wherein the automated email message is sent to an administrator of the email server associated with the invalid email address.

3. The method of claim 1, wherein the automated email message is sent to an owner of the distribution list.

4. The method of claim 1, wherein the automated email message is sent to the invalid email address after a delay.

5. The method of claim 1, additionally comprising:
preventing repeated queries of the email server a bout validity of a single email address, based on presence of the single email address in at least two distribution lists.

6. The method of claim 1, additionally comprising:
determining that available CPU resources of the email server are above a second threshold value; and
where the second threshold value is exceeded, opening a connection with the email server.

7. The method of claim 1, additionally comprising:
attaching a digital signature to the automated email message to reassure that the automated email message is from a trusted source.

8. The method of claim 1, additionally comprising:
evaluating available CPU resources of email servers;
ranking the email servers according to available CPU resources; and
selecting the email server from the email servers according to their rank.

9. The method of claim 1, additionally comprising:
evaluating available CPU resources of email servers;
ranking the email servers, having available CPU resources exceeding a second threshold, according to number of email addresses within the distribution list; and
selecting the email server from the email servers according to their rank.

10. A method to validate an invalid email address, comprising:
delaying to allow a technical problem to be resolved;
sending an html format email, containing a code, from a digital transmitter to the invalid email address;
causing a third party email service to send a reply to the digital transmitter, wherein the reply includes a copy of the code, if the html format email is opened by an owner of the invalid email address;
comparing the code to the copy of the code; and
where the code and the copy of the code match, reclassifying the invalid email address as a valid email address.

11. A processor-readable medium comprising processor-executable instructions for:
determining that available CPU resources of a digital transmitter exceed a threshold value;
querying an email server to determine if an email address contained within a distribution list on the digital transmitter is still valid;
where the email address is an invalid email address, sending an automated email message asking for an updated email address; and
if a reply is sent, receiving the reply containing the updated email address and replacing the invalid email address with the updated email address.

12. A processor-readable medium as recited in claim 11, additionally comprising instructions for:
preventing repeated queries of the email server about validity of a single email address, based on presence of the single email address in at least two distribution lists.

13. A processor-readable medium as recited in claim 11, additionally comprising instructions for:
determining that available CPU resources of the email server are above a second threshold value; and
where the second threshold value is exceeded, opening a connection with the email server.

14. A processor-readable medium as recited in claim 11, additionally comprising instructions for:
attaching a digital signature to the automated email message to reassure that the automated email message is from a trusted source.

15. A processor-readable medium as recited in claim 11, additionally comprising instructions for:
evaluating available CPU resources of email servers;
ranking the email servers according to available CPU resources; and
selecting the email server from the email servers according to their rank.

16. A processor-readable medium as recited in claim 11, additionally comprising instructions for:
evaluating available CPU resources of email servers;
ranking the email servers, having available CPU resources exceeding a second threshold, according to number of email addresses within the distribution list; and
selecting the email server from the email servers according to their rank.

17. A processor-readable medium comprising processor-executable instructions for validating an invalid email address, the processor-executable instructions comprising instructions for:
sending an html format email, containing a code, from the digital transmitter to the invalid email address;
causing a third party email service to send a reply to the digital transmitter, wherein the reply includes a copy of the code, if the html format email is opened by an owner of the invalid email address;
comparing the code to the copy of the code; and
where the code and the copy of the code match, reclassifying the invalid email address as a valid email address.

18. A processor-readable medium comprising processor-executable instructions for maintaining distribution lists on a digital transmitter, the processor-executable instructions comprising instructions for:
reviewing at least two distribution lists;
consolidating the at least two distribution lists to result in a list of unique email addresses; and
grouping email addresses within the list of unique email addresses according to an associated email server.

19. A processor-readable medium as recited in claim 18, additionally comprising instructions for:
evaluating available CPU resources of email servers;
ranking email servers according to available CPU resources; and
selecting an email server to which to open a connection from the email servers according to rank.

20. A processor-readable medium as recited in claim 18, additionally comprising instructions for:
where an email address is thought to be an invalid email address, sending an automated email message to an administrator of the email server.

21. A processor-readable medium as recited in claim 20, additionally comprising instructions for:
after a delay, sending an html format email, containing a code, from a digital transmitter to the invalid email address;
causing a third party email service to send a reply to the digital transmitter, wherein the reply includes a copy of the code, if the html format email is opened by an owner of the invalid email address;
comparing the code to the copy of the code; and
where the code and the copy of the code match, reclassifying the invalid email address as a valid email address.

22. A digital transmitter, comprising:
a CPU resource evaluator module configured to determine that available CPU resources of a digital transmitter exceed a threshold value;
an email server query module configured to query an email server to determine if an email address is still valid; and
an administrator messaging module, for use when the email address is an invalid email address, configured to send an automated email message to an administrator of the email server associated with the invalid email address asking for an updated email address.

23. The digital transmitter of claim 22, additionally comprising:
an email server resource evaluation module configured to determine that available CPU resources of the email server are above a second threshold value; and
wherein the email server query module is additionally configured, where the second threshold value is exceeded, to open a connection with the email server.

24. The digital transmitter of claim 22, additionally comprising:
a digital signature module configured to attach a digital signature to the automated email message to reassure the administrator that the automated email message is from a trusted source.

25. The digital transmitter of claim 22, additionally comprising:
a distribution list owner mailer module configured to send, if the administrator does not send a reply, a second automated email message to an owner of a distribution list, within which the invalid email address is contained, indicating that the invalid email address is invalid.

26. The digital transmitter of claim 22, additionally comprising:
a distribution list member mailer module configured to send, after a delay, an html format email, containing a code, from the digital transmitter to the invalid email address;
wherein the html format email is configured to cause an automatic reply to the digital transmitter, including a copy of the code, upon opening by an owner of the invalid email address;
a comparator module configured to compare the code to the copy of the code; and a list manager module configured to reclassify, where the code and the copy of the code match, the invalid email address as a valid email address.

27. A digital transmitter configured to maintain distribution lists, comprising:
means for determining that available CPU resources of the digital transmitter exceed a threshold value;
means for querying an email server to determine if an email address contained within a distribution list is still valid;
where the email address is an invalid email address, means for sending an automated email message to an administrator of the email server associated with the invalid email address asking for an updated email address; and
if the administrator sends the updated email address, means for replacing the invalid email address with the updated email address.

28. The digital transmitter of claim 27, additionally comprising:
means for reviewing at least two distribution lists;
means for consolidating the at least two distribution lists to result in a list of unique email addresses; and
means for grouping email addresses within the list of unique email addresses according to an associated email server.

29. The digital transmitter of claim 27, additionally comprising:
means for after a delay, sending an html format email, containing a code, from the digital transmitter to the invalid email address;
means for causing the html format email to automatically reply to the digital transmitter, with a copy of the code, if opened by an owner of the invalid email address;
means for comparing the code to the copy of the code; and
means for reclassifying the invalid email address as a valid email address, where the code and the copy of the code match.

30. The digital transmitter of claim 27, additionally comprising:
means for evaluating available CPU resources of email servers;
means for ranking the email servers according to available CPU resources; and
means for selecting the email server from the email servers according to their rank.
